(19) United States
(12) Patent Application Publication
(10) Pub. No.: US 2020/0263832 A1
(43) Pub. Date: Aug. 20, 2020

(54) CONSTANT-PRESSURE STORAGE UNIT

(71) Applicant: LINDE AKTIENGESELLSCHAFT, MUNICH (DE)

(72) Inventors: Robert Adler, Gerasdorf (AT); Sascha Domer, Gramatneusiedl (AT); Markus Rasch, Sulz im Wienerwald (AT); Michael Stefan, Zillingdorf (AT)

(73) Assignee: LINDE AKTIENGESELLSCHAFT, MUNICH (DE)

(21) Appl. No.: 16/061,500

(22) PCT Filed: Nov. 24, 2016
(86) PCT No.: PCT/EP2016/001984

§ 371 Date: Jun. 12, 2018

(30) Foreign Application Priority Data
Dec. 15, 2015 (DE) 10 2015 016 326.4

(51) Int. Cl. F17C 11/00; F17C 5/06

(52) U.S. Cl. CPC F17C 11/005; F17C 5/06; F17C 2270/0139; F17C 2205/0332; F17C 2250/043; F17C 2221/012; F17C 2265/065

(57) ABSTRACT

A constant-pressure storage unit and a method for operating a constant-pressure storage unit, for storing and dispensing hydrogen under constant pressure are disclosed. The constant-pressure storage unit has at least one constant-pressure store, which is divided into two regions by a movable separating piston, at least one liquid pump for conveying a liquid, and at least one liquid store, wherein a measuring device measures the liquid level in the liquid store and sends a signal to the liquid pump by means of a control unit. In this way, the liquid pump can be stopped in time when the constant-pressure storage unit is empty.

The invention pertains to a constant-pressure storage unit for storing a gas under constant pressure, wherein said constant-pressure storage unit comprises at least one constant-pressure store, which is divided into two regions by a movable separating piston, at least one liquid pump for conveying a liquid and at least one liquid store. The invention furthermore pertains to a method for operating such a constant-pressure storage unit, particularly for storing hydrogen.

The term constant-pressure storage unit refers to a device that can be used, in particular, for filling smaller mobile or stationary storage tanks. The constant-pressure storage unit itself may be realized stationarily, particularly as part of a filling station, or in a mobile fashion as part of a tanker truck. A constant-pressure storage unit generally comprises one or more constant-pressure stores, a liquid supply, i.e. at least one liquid pump, as well as at least one reservoir for the liquid and, if applicable, a gas-conditioning unit for adapting the gas to the requirements of the consumer. It goes without saying that different valves, controllers and sensors are furthermore provided for the operation of the system.

The use of constant-pressure stores makes it possible to eliminate the need for compressors between the constant-pressure store and the consumer. The investment and maintenance costs can thereby be lowered.

Conventional pressure storage systems undergo numerous load alternations while they are emptied and filled. In the storage of gaseous fuel, particularly hydrogen, the storage capacities are primarily increased by using higher storage pressures. However, this additionally increases the stress caused by load alternations. Due to the increasing demand for hydrogen and the commissioning of hydrogen filling stations, the demand for stable, durable and low-maintenance storage systems increases accordingly. However, conventional materials and devices are cost-intensive or not sufficiently stable. As already mentioned in WO2015051894, constant-pressure storage units provide a suitable alternative because the number of load alternations is significantly reduced. In this way, the service life of filling stations can be significantly extended. Constant-pressure storage units for compressed natural gas, which are designed for a maximum storage pressure of 300 bar, are primarily known from the state of the art.

Constant-pressure stores are designed for making available a gas with a certain constant pressure to consumers and therefore belong to the group of gas pressure stores. The pressure in a gas store is typically dependent on its filling level and the pressure has to be adapted, for example by means of compressors, during the delivery of the gas to the consumer. The constant-pressure stores themselves can be filled in an injection phase by means of mobile systems such as, for example, corresponding tanker trucks or also stationarily, for example, by means of pressure boosting systems. A constant-pressure store generally comprises a cylinder that is divided into two regions by a movable separating piston. A first region is designed for accommodating a gas and a second region is designed for accommodating a liquid.

The principle of a constant-pressure store is based on keeping the pressure of the gas constant in the first region during an injection phase by increasing the volume in the first region, wherein this is achieved in that the separating piston is displaced and the volume of the second region is reduced. During the withdrawal phase, the volume of the first region is reduced in that more liquid is conveyed into the second region and the volume of the second region is increased such that the pressure in the first region in turn remains constant. The withdrawal phase can also be interpreted as a phase, in which the gas is dispensed from the constant-pressure store.

However, if all the gas is dispensed from a constant-pressure store during the withdrawal phase, the piston moves as far as into the end position. This means that the first region for the gas is minimal or no longer existent and the second region for the liquid has reached its maximum volumetric capacity. At this point, the liquid pump has to be shut off because the pressure in the constant-pressure store would otherwise reach values above its maximum design pressure. One problem can be seen in that the pressure increase takes place very fast. The corresponding reaction times required for stopping the liquid pump are therefore very short. However, the pressure increase results in an unnecessary energy loss, damages to the pump or even the discharge of liquid from a pressure relief valve. This problem not only arises in a constant-pressure store, but also in constant-pressure storage units with multiple constant-pressure stores because one store will ultimately always reach its end position and thereby cause a pressure increase.

The present invention is therefore based on the objective of disclosing a method and a corresponding system, by means of which the liquid pump can be sopped in time for preventing an impermissible pressure increase.

With respect to the method and the system, this objective is attained in that a measuring device measures the liquid level in the liquid store and delivers a signal to the liquid pump by means of a control unit. To this end, the liquid store contains a measuring device that serves for determining the level of the liquid and is connected to the liquid pump by means of a control unit. The measuring device preferably measures a minimum or maximum liquid level in the liquid store and the supply or discharge of liquid into or from the at least one constant-pressure store is stooped. The quantity of liquid required for completely filling the constant-pressure store or constant-pressure stores, i.e. for discharging all the gas from the constant-pressure store, is known and typically stored in the liquid store. The measurement of the liquid level in the liquid store therefore makes it possible to deduce the quantity of liquid in the constant-pressure store or constant-pressure stores and therefore the position of the pistons. The liquid pump can thereby be stopped once the liquid level drops below a defined minimum value. It would also be conceivable to already reduce the delivery rate when the liquid level approaches the defined minimum value.

In this way, the pressure does not increase to impermissible values and the pressure relief valve does not have to be opened. This enhances the operational reliability of a constant-pressure storage unit. No product escapes into the environment. Damage to the system or a product loss is likewise prevented such that the efficiency is improved and the service life of the system is extended.

With respect to the constant-pressure storage unit, it is advantageous to use water or hardly inflammable hydraulic fluids, which contain water and polyglycol (e.g. HFC), or hydraulic fluids based on minimal oil (e.g. HLP) as fluid in the second region. The hydrogen in the first region is preferably stored at a pressure of 235 to 5000 bar, particularly 301 to 1200 bar, preferably at 620, 650, 900 or 1000 bar. The same pressure accordingly has to be exerted by the liquid in the second region.

The measuring device for determining the level of the liquid preferably consists of a level sensor that detects the changes in he filling level of the liquid store, particularly an ultrasonic sensor, a pressure sensor or a position measuring system with floats. Multiple sensors may also be used.

It would also be conceivable to use one or more scales for measuring the weight of the liquid store and thereby deducing the quantity of liquid or to use a mass or volume flow meter between the liquid store and the constant-pressure stores.

A constant-pressure storage unit advantageously comprises one, two, three, four or more constant-pressure stores.

In this measuring principle, multiple constant-pressure stores are preferably connected to a liquid pump and only one liquid store. The system costs are thereby reduced.

It would also be possible to measure the end position of the separating piston itself. Inductive, capacitive, ferromagnetic, ultrasonic or other measuring devices could conceivably be used for this purpose. However, these measuring devices would have to be installed separately in each constant-pressure store such that the investment costs are increased.

Depending on the measuring principle used, a signal is delivered to the liquid pump by means of an electrical connection in order to stop or start the liquid supply. In this case, the electrical connection may be realized directly or indirectly. It may be produced by means of a cable or in a wireless fashion.

Another advantage of the inventive method and the corresponding system can be seen in that the measurement of the quantity of liquid can also be used for detecting the dispensed quantity of gas regardless of whether the quantity of liquid is measured by determining the liquid level, weighing the liquid store or arranging a mass or volume flow meter between the liquid store and the constant-pressure stores. The dispensed or also the injected gas quantity can be deduced because the volume, by which the first region for the gas in the constant-pressure store has to be reduced, is known.

The utilization of such a method and such a system therefore simultaneously provides multiple advantages.

As an alternative to measuring the end position of the separating piston, a strong spring may be installed on this separating piston on the side of the first region, i.e. on the side of the gas. Due to this spring, the pressure would measurably increase prior to reaching the end position and thereby generate a usable shutoff signal. Such a spring preferably has a spring force of about 20,000 N and a length of about 200 mm.

Constant-pressure storage units of this type not only can be used for storing and dispensing hydrogen, but also other compressed gases, particularly natural gas or other gases containing hydrocarbons. It would also be conceivable to use such constant-pressure storage units for nitrogen, helium, oxygen, fluorine or boron trifluoride.

An exemplary embodiment of the invention is described below with reference to a schematic figure. Valves, control and sensor units, which a person skilled in the art would usually provide for the operation of the system, are not illustrated in order to provide a better overview.

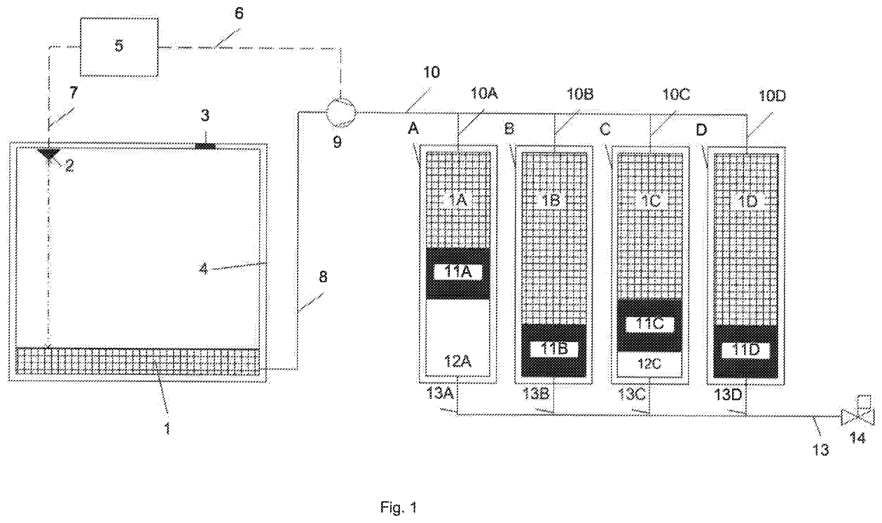

FIG. 1 schematically shows the configuration of a constant-pressure storage unit.

FIG. 1 shows a potential design variation of a constant-pressure storage unit. This constant-pressure storage unit comprises a liquid store 4, in which a liquid 1, in this case a hardly inflammable hydraulic fluid, is stored. The liquid store 4 also contains a measuring device 2, which is particularly realized in the form of an ultrasonic sensor or ultrasonic level sensor, in order to detect the quantity of liquid 1 remaining in the liquid store 4. The liquid store 4 furthermore comprises a safety valve 3, which may be realized in the form of a bursting disk, an overflow valve or other pressure relief devices familiar to a person skilled in the art. The measuring device 2 is connected to a control unit 5 and a liquid pump 9 by means of electrical connections 6 and 7. The liquid pump 9 for conveying the liquid 1 is furthermore connected to the liquid store 4 by means of the liquid line 8.

The liquid 1 is stored in the liquid store 4 with the ambient temperature, i.e. in a range between −40° C. and +80° C., and a pressure of 301 to 1200 bar. The liquid 1 is conveyed into the constant-pressure stores A to D by means of the liquid pump 9 and the liquid line 10 (or 10A, 10B, 10C, 10D) in order to move the separating piston 11 (A to D) therein and to thereby keep the pressure of the gas, in this example hydrogen 12 (12A and 12C), constant.

In the exemplary embodiment shown, all constant-pressure stores share a liquid store 4 for the liquid 1. The gas, particularly hydrogen 12, is injected and withdrawn into: from the constant-pressure stores by means of the transport line 13 (or 13A, 13B, 13C, 13D) and the shutoff valve 14. The pressure of the hydrogen 12 lies between 301 and 1200 bar.

In the injection phase, the constant-pressure stores A to D are filled with the gas, i.e. with hydrogen 12, by means of the transport lines 13. During this process, the separating pistons 11A, 11B, 11C, 11D are displaced in such a way that the region for the liquid 1 is minimal and the region for the hydrogen 12 is maximal. The liquid 1 is stored in the liquid store 4.

In the withdrawal phase, hydrogen is dispensed from the constant-pressure storage unit. In this case, liquid 1 is conveyed from the liquid store 4 into the constant-pressure stores A, B, C and/or D by means of the liquid line 8, the liquid pump 9 and the transport lines 10 (or 10A, 10B, 10C, 10D). In this case, the separating pistons 11A, 11B, 11C and/or 11D are displaced in such a way such that the region for the liquid 1 is maximal and the region for the hydrogen 12 is minimal. In the exemplary embodiment shown, the liquid level in the liquid store 4 is measured by means of a measuring device 2, namely an ultrasonic sensor. Once the liquid level reaches a minimum value, the liquid pump 9 is stopped by means of the control unit 5 and the electrical connections 7 and 6. At this point, the separating pistons 11A, 11B, 11C and 11D have reached their end position within the constant-pressure stores A, B, C, D, in which the constant-pressure stores are filled with a maximum quantity of liquid 1 (1A, 1B, 1C, 1D) and the gas has been completely or almost completely dispensed. A pressure peak within the constant-pressure stores can be prevented by stopping the liquid pump 9, i.e. the liquid supply.

In other embodiments, different measuring principles and different measuring devices may be used for stopping the liquid supply.

### LIST OF REFERENCE SYMBOLS

1 Liquid in liquid store
1A, 1B, 1C, 1D Liquid in constant-pressure store
2 Measuring device
3 Safety valve
4 Liquid store
5 Control unit
6, 7 Electrical connection
8 Liquid line
9 Liquid pump
10, 10A, 10B, 10C, 10D Liquid line
11A, 11B, 11C, 11D Separating piston in constant-pressure store
12A, 12C Gas in constant-pressure store
13, 13A, 13B, 13C, 13D Transport line for gas
14 Shutoff valve
A, B, C, D Constant-pressure store

1. A method for operating a constant-pressure storage unit for storing and dispensing hydrogen under constant pressure, wherein said constant-pressure storage unit comprises at least one constant-pressure store, which is divided into two regions by a movable separating piston, at least one liquid pump for conveying a liquid and at least one liquid store, characterized in that a measuring device measures a liquid level in the liquid store and delivers a signal to the liquid pump by a control unit.

2. The method according to claim 1, characterized in that the liquid supply or liquid discharge into or from the at least one constant-pressure store is stopped when the measuring device measures a minimum or maximum liquid level in the liquid store.

3. The method according to claim 1, characterized in that the constant-pressure storage unit uses fluids selected from the group consisting of hardly inflammable hydraulic fluids comprising water and polyglycol, and hydraulic fluids comprising mineral oil as liquid in the second region.

4. The method according to claim 1, characterized in that the hydrogen in the first region is stored at a pressure of 235 to 5000 bar.

5. The method according to claim 1, characterized in that the measuring device used consists of a filling level sensor.

6. A constant-pressure storage unit for storing a gas under constant pressure, comprising at least one constant-pressure store, which is divided into two regions by a movable separating piston, at least one liquid pump for conveying a liquid and at least one liquid store, characterized in that the liquid store contains a measuring device, which serves for determining the level of the liquid and is connected to the liquid pump by a control unit.

7. The constant-pressure storage unit according to claim 6, characterized in that multiple constant-pressure stores are connected to a liquid pump and only one liquid store.

8. The constant-pressure storage unit according to claim 6, characterized in that the measuring device for determining the level of the liquid is selected from the group consisting of a level sensor, which detects the changes in the filling level of the liquid store, a pressure sensor and a position measuring system with floats.

9. The constant-pressure storage unit according to claim 6, characterized in that the constant-pressure storage unit stores is a gas in the form of hydrogen.

10. The constant-pressure storage unit according to claim 6, characterized in that the constant-pressure storage unit is at a pressure of 235 to 5000 bar.

11. The constant-pressure storage unit according to claim 8, characterized in that the level sensor is an ultrasonic sensor.

12. The constant-pressure storage unit according to claim 10, characterized in that the constant-pressure unit is at a pressure of 301 to 1200 bar.

13. The constant-pressure storage unit according to claim 10, characterized in that the constant-pressure unit is at a pressure selected from the group consisting of 620, 850, 900 and 1000 bar.
